(19) United States
(12) Patent Application Publication
(10) Pub. No.: US 2018/0260850 A1
(43) Pub. Date: Sep. 13, 2018

(54) Systems and Methods for Improving Advertising in Fitness Centers Based on Traffic

(71) Applicant: Brunswick Corporation, Mettawa, IL (US)

(72) Inventor: Amad Amin, Streamwood, IL (US)

(73) Assignee: Brunswick Corporation, Mettawa, IL (US)

(21) Appl. No.: 15/907,376

(22) Filed: Feb. 28, 2018

Related U.S. Application Data
(60) Provisional application No. 62/470,557, filed on Mar. 13, 2017.
(60) Provisional application No. 62/472,900, filed on Mar. 17, 2017.

(51) Int. Cl. G06Q 30/02

(52) U.S. Cl. CPC G06Q 30/0261; G06Q 30/0269

(57) ABSTRACT

A method for advertising to patrons of a fitness center using a collection of assets. The method includes creating a map of the collection of assets based on location, detecting and recording use data for individual assets within the collection of assets as a function of time, and comparing the use data to determine a popularity for each of the individual assets. The method includes accessing a collection of advertisements available for advertising to the patrons, then assigning specific advertisements within the collection of advertisements to each of the individual assets based on the popularity determined for each of the individual assets. The method includes outputting an advertisement plan indicating which of the specific advertisements to expose to the patrons using each of the individual assets, wherein the advertising plan is based on the assignment of the specific advertisements to each of the individual assets.

### CROSS REFERENCE TO RELATED APPLICATIONS

This application claims the benefit of U.S. Provisional Patent Application Nos. 62/470,557 filed Mar. 13, 2017 and 62/472,900 filed Mar. 17, 2017, which are incorporated herein by reference in their entireties.

### FIELD

The present disclosure relates to advertising in fitness centers and particularly to systems and methods for advertising in fitness centers based on exercise machine usage traffic.

### BACKGROUND

The following U.S. patents are hereby incorporated herein by reference:

U.S. Pat. Nos. 7,115,076; 7,846,070; 6,783,482; and 6,626,803 disclose a microprocessor-based exercise treadmill control systems which include various features to enhance user operation.

U.S. Pat. Nos. 8,652,051; 8,574,131; 8,403,814; 8,157,708; and 7,914,420 disclose sensing applications for profiling a workout session of an exercise machine, comprising a user interface to input physical characteristics and/or workout parameters.

U.S. Pat. Nos. 9,238,158; 9,216,317 disclose stair climber apparatuses having a frame with an inclined support that extends from a bottom portion to a top portion, a plurality of stairs that are connected together in series and travel in a loop around the inclined support, an electric motor, and a control circuit that controls a speed of the electric motor and an output direction of the electric motor.

U.S. Pat. Nos. 9,283,425; 9,138,614; 9,114,275 and 9,050,498 disclose exercise assemblies comprising a frame and elongated foot pedal members that are each movable along user-defined paths of differing dimensions.

### SUMMARY

This Summary is provided to introduce a selection of concepts that are further described herein below in the Detailed Description. This Summary is not intended to identify key or essential features of the claimed subject matter, nor is it intended to be used as an aid in limiting scope of the claimed subject matter.

Certain embodiments of the present disclosure generally relate to a method for advertising to patrons of a fitness center using a collection of assets. The method includes creating a map of the collection of assets based on location within the fitness center, and detecting and recording use data for individual assets within the collection of assets as a function of time. The method further includes comparing the use data among each of the individual assets to determine a popularity for each of the individual assets. The method further includes accessing a collection of advertisements available for advertising to the patrons, then assigning specific advertisements within the collection of advertisements to each of the individual assets within the collection of assets based on the popularity determined for each of the individual assets. The method includes outputting an advertisement plan indicating which of the specific advertisements within the collection of advertisements to expose to the patrons using each of the individual assets within the collections of assets, wherein the advertising plan is based on the assignment of the specific advertisements to each of the individual assets.

Additional embodiments of the present disclosure generally relate to a system for advertising to patrons of a fitness center using a collection of assets. The system includes a map module configured to store a map of the collection of assets based on location within the fitness center. A use recording module is configured to record use data for individual assets within the collection of assets as a function of time. A comparison module is configured to compare the use data among each of the individual assets to determine a popularity for each of the individual assets. A communications module is configured to access a collection of advertisements available for advertising to the patrons. An assignment module is configured to assign specific advertisements within the collection of available advertisements to each of the individual assets within the collection of assets based on the popularity determined for each of the individual assets. An output module is configured to output an advertisement plan that indicates which of the specific advertisements to expose to the patrons using each of the individual assets within the collections of equipment.

### BRIEF DESCRIPTION OF THE DRAWINGS

FIG. 1 is a schematic depiction of an exemplary system for advertising and selling items to patrons at a fitness center.

FIG. 2 is a flow chart depicting an exemplary method for advertising and selling items to patrons at a fitness center.

FIG. 3 is a schematic depiction of an exemplary system for illustrating usage of exercise machines at a fitness center.

FIG. 4 is an exemplary operator's display.

FIG. 5 is a flow chart depicting an exemplary method for monitoring and displaying usage of exercise machines at a fitness center.

FIGS. 6-8 are flow charts depicting exemplary methods for advertising to patrons at a fitness center based on the usage of equipment or traffic.

FIG. 9 is a schematic depiction of an exemplary system for advertising to patrons at a fitness center based on the usage of equipment or traffic.

FIG. 10 is an exemplary map of equipment within a fitness center for use with the methods and systems depicted in FIGS. 6-8 and 10.

### DETAILED DESCRIPTION OF THE DRAWINGS

Through research and development, the present inventor has realized that it would be advantageous to provide improved systems and methods for advertising and selling items to patrons at a fitness center. In particular, the present inventor realized that it would be advantageous to provide the patrons of fitness centers with advertising information regarding items for sale (including goods and/or services) and also with the ability to purchase the items while exercising. These goods and services include those provided by the fitness center itself (i.e., branded apparel and personal trainer sessions), and/or those provided by third-parties (i.e., nutritional supplements and fitness equipment). The present inventor has also realized that it would be advantageous to give operators of fitness centers the ability to select and offer items for sale to their patrons while the patrons are exercising. The present inventor has further realized that it would be advantageous for both patrons and operators of fitness centers to provide systems and methods that communicatively network or otherwise link display and input devices on exercise machines at a fitness center to the fitness center's client management systems. An exemplary client management system may include programs currently provided by third-party companies (e.g., ABC Financial) containing patron credit account information. This information may include, for example, the patron's credit account at the fitness center, the patron's credit card account, the patron's PayPal® account, and/or the like.

The present inventor has further realized that it would be advantageous for both patrons and operators of fitness centers to provide systems and methods that communicatively network or otherwise link the display and input devices on exercise machines at a fitness center to the fitness center's client management system, and also to third-party sellers, for example via the internet. The present inventor has further realized that it would be advantageous (for both patrons and operators of fitness centers) to provide systems and methods that communicatively network or otherwise link the display and input devices on exercise machines at a fitness center to the fitness center's client management system, and also to the patron's personal email or other similar electronic messaging account for providing receipts of purchase.

The present inventor has realized that the above described systems and methods can enhance revenue streams to the owners and operators of fitness centers and/or to manufacturers of the exercise machines or other advertising assets. While the patrons are exercising, they constitute a “captive audience” for advertising and selling goods and services of the fitness center, as well as goods and services of third-party suppliers. Therefore, embodiments communicatively linking the display and input devices on the exercise machines to the client management system of the fitness center allow the entire system to be programmed and/or actively controlled to identify and select the particular items offered for sale to the patron. This identification and selection is based upon one or more known characteristics of the patron, for example the patron's history of exercise activity and/or purchases, the patron's age, the patron's gender, and the like. Further, the present inventor has realized that while the patron is using an exercise machine or an asset of the fitness center more generally, the patron will often identify a particular food or drink, an item of clothing or other consumer item, or an exercise services, such as a class or a personal training session provided by the fitness center, that the patron would like to purchase, including by exposure to advertisements within the fitness center.

The above-described systems and methods thus provide the patron and operator of the fitness center with an efficient means by which to advertise such items and to complete the sale transaction. Communicatively linking the display and input devices on the exercise machines to the client management system can advantageously provide a cashless transaction system, which improves efficiency for both the patron and the operator of the fitness center. Optionally, certain embodiments of systems and methods disclosed herein provide the patron with the ability to select and purchase goods and/or services through a single contact with the display and input device (i.e., one-touch). This once again improves the efficiency and overall experience of both the patron and the fitness center owner.

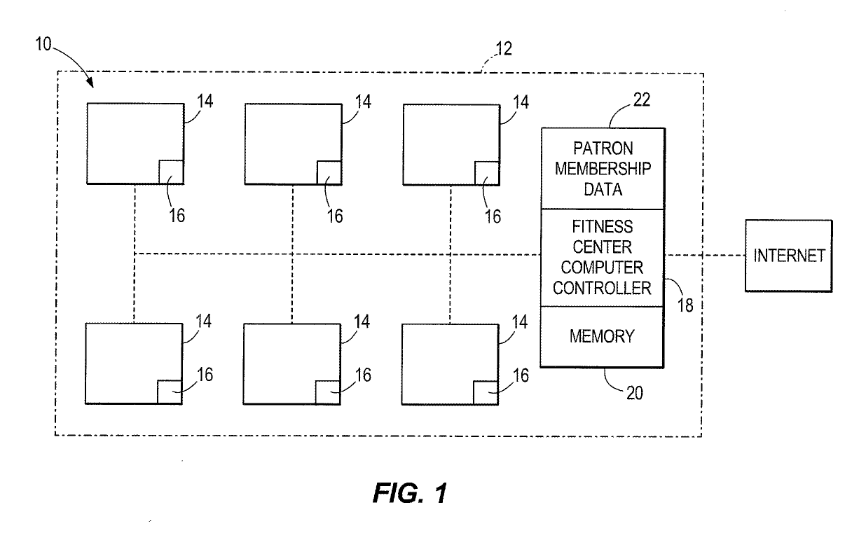

FIG. 1 depicts one example of a system 10 according to the present disclosure for advertising and selling items at a fitness center 12. A plurality of exercise machines 14 is located at the fitness center 12. The type and configuration of exercise machines 14 can vary, and for example can include treadmills, stair climbers, stationary bicycles, and/or the like. Examples of suitable exercise machines 14 are provided in the above-incorporated patents. Certain exercise machines 14 have a display and input device 16. The type of display and input device 16 can vary. In some examples, the display and input device 16 includes a conventional touchscreen, such as disclosed in the above-incorporated patents. As is conventional and further disclosed in the above-incorporated patents, patrons of the fitness center can also view and control operational characteristics of the respective exercise machine 14 via the display and input device 16.

The system 10 further includes a fitness center computer controller 18. The configuration of the fitness center computer controller 18 can vary, and in most examples includes a memory and a programmable processor. The processor can be communicatively connected to a computer readable medium that includes volatile or nonvolatile memory upon which computer readable code is stored. The processor can access the computer readable code, and the computer readable medium upon executing the code carries out functions as described herein below. In other examples of the system 10, more than one controller is provided, rather than the single controller as shown herein. The fitness center computer controller 18 is connected to memory 20 that stores credit account information for each patron and that optionally stores other information regarding each patron, for example the patron's history of exercise activity, the patron's age, the patron's gender and/or the like.

A computer network (shown generally in dashed line format) communicatively connects each display and input device 16 to the fitness center computer controller 18. It should be noted that the dashed lines shown in FIG. 1 are only meant to show that the various control elements shown therein are capable of communicating with one another, and do not represent actual wiring connecting the control elements, nor do they represent the only paths of communication between the elements. The connections shown herein could be wired (for example, serially wired) or wireless.

Furthermore, certain aspects of the present disclosure are described herein in terms of functional and/or logical block components and various processing steps. It should be recognized that any such functional and/or block components and processing steps may be realized by any number of hardware, software, and/or firmware components configured to perform the specified functions. For example, certain embodiments employ various integrated circuit components, such as memory elements, digital signal processing elements, logic elements, look-up tables, or the like, which are configured to carry out a variety of functions under the control of one or more processors or other control devices.

These functions may also include the use of computer programs that include processor-executable instructions, which may be stored on a non-transitory tangible computer readable medium. The computer programs may also include stored data. Non-limiting examples of the non-transitory tangible computer readable medium are nonvolatile memory, magnetic storage, and optical storage. As used herein, the term module may refer to, be part of, or include an application-specific integrated circuit (ASIC), an electronic circuit, a combinational logic circuit, a field programmable gate array (FPGA), a processor (shared, dedicated, or group) that executes code, or other suitable components that provide the described functionality, or a combination of some or all of the above, such as in a system-on-chip. The term module may include memory (shared, dedicated, or group) that stores code executed by the processor. The term code, as used herein, may include software, firmware, and/or microcode, and may refer to programs, routines, functions, classes, and/or objects. The term shared, as used above, means that some or all code from multiple modules may be executed using a single (shared) processor. In addition, some or all code to be executed by multiple different processors may be stored by a single (shared) memory. The term group, as used above, means that some or all code comprising part of a single module may be executed using a group of processors. Likewise, some or all code comprising a single module may be stored using a group of memories.

In the embodiment of FIG. 1, the fitness center computer controller 18 is configured to communicate with each display and input device 16 on the various exercise machines 14 to display one or more items for sale to the patron while the patron is using the exercise machine 14. Each display and input device 16 is configured so that a patron can input an order to purchase the item for sale (i.e., select an item that they want to purchase). Upon entry of the order to purchase, the fitness center computer controller 18 is further configured to validate and apply the credit account information of the patron, thereby completing payment for the items for sale. The items offered for sale can vary and can, for example, include tangible goods located at the fitness center (e.g., goods originating from the fitness center and/or goods originating from third-party supplies/manufacturers) and/or services provided at the fitness center 12. In some examples, the fitness center computer controller 18 can be programmed to automatically to select the items for sale to be shown to a given patron based at least in part on the membership data 22 for that given patron. This advantageously provides a personalized, directed approach to advertising and selling to the patron. This targeted approach also enhances the potential for revenue stream to the operator of the fitness center 12 and optionally to the third-party supplier/manufacturer and/or manufacturer of the exercise machines 14.

For security, the fitness center computer controller 18 in certain embodiments is configured to require validation of a personal identification key for the respective patron prior to allowing entry of the order to purchase. For example the personal identification key can be a passcode entered by the patron into the display and input device. This verification may occur as a process to logging into an individual asset, or as a secondary confirmation for making a purchase. In other examples, the personal identification key is a radio frequency identification key emitted by a transmitter carried by the patron.

Optionally, the computer network can also or instead be connected to the internet such that the fitness center computer controller 18 is configured to display items for sale from third-party websites. The fitness center computer controller 18 can be configured to identify and select items for sale from the third-party websites based upon information about the respective patron from the fitness center's client management systems.

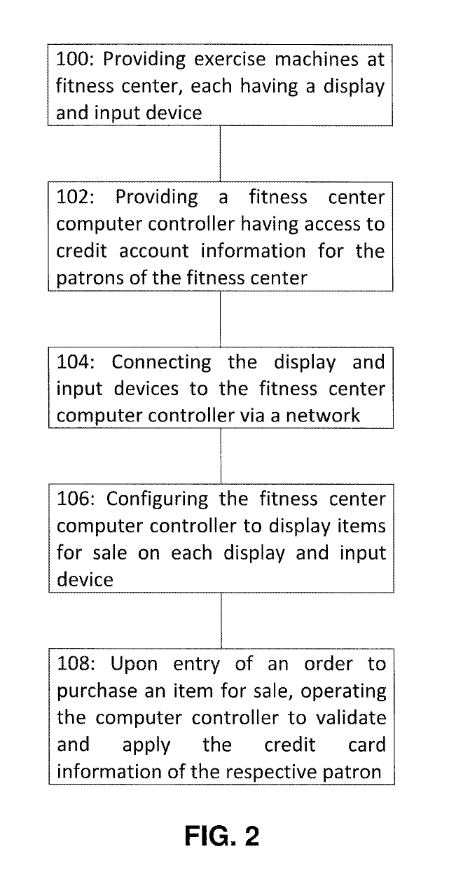

Referring to FIG. 2, the present disclosure thus provides new methods for advertising and selling items at a fitness center. The methods can comprise: (step 100) providing a plurality of exercise machines located at the fitness center, each respective exercise machine having a display and input device via which patrons of the fitness center can control an operational characteristic of the respective exercise machine; (step 102) providing a fitness center computer controller having access to a memory that stores credit account information for each patron; (step 104) connecting the display and input devices and the fitness center computer controller via a computer network so that the fitness center computer controller communicates with each display and input device via the computer network; and (step 106) configuring the fitness center computer controller to display items for sale on each display and input device so that each respective patron can input an order to purchase one of the items for sale, and (step 108) wherein upon entry of the order to purchase to the display and input device, the fitness center computer controller is configured to validate and apply the credit account information of the respective patron to thereby complete payment for the item for sale.

Through research and development, the present inventor has further determined that it would be advantageous to enable operators of fitness centers to more efficiently and effectively monitor usage of the exercise machines 14 in real-time, or at least at periodic intervals. The present inventor has further determined that it would be advantageous to provide operators of fitness centers with a visual display that visually depicts usage of exercise machines 14 in real-time or at periodic intervals. The present inventor has further determined that it would be advantageous to configure an operator's display to provide a visual “heat map”, i.e., wherein colors or other visual characteristics of icons representing the exercise machines are automatically changed based upon relative usage amounts. For example, the more a certain exercise machine is used (either considered in isolation or relative to the remaining exercise machines in total or within a group), the more intense a color can be displayed for the icon representing that machine. Conversely, the less a certain exercise machine is used, the less intense a color can be displayed for the icon representing that machine. This can also take into account time of day, day of week, and type of asset (i.e., fitness machine).

With this type of visual aid, the present inventor has determined that the operator will have the ability to better control the display and input devices 16 to tailor advertisements presented to the patrons, for example in accordance with the above-described methods and systems for advertising and selling items. The present inventor has determined that, based on the distribution of usage across the various exercise machines, the operator can control the type and amount of advertisements displayed on relatively higher-usage exercise machines, and which advertisements are displayed on relatively lower-usage machines, etc. This can advantageously facilitate a better revenue stream to the operator of the fitness center. The present inventor has also determined that the operator can use the visual aid to understand patron traffic patterns and usage of the respective machines, to (1) place accessories/goods in the high traffic areas to increase the likelihood of purchase, and/or (2) position personal trainers in high traffic areas and/or during peak times to help the patrons and/or sell personal training services, etc. The systems and methods disclosed herein can also help change the way operators of fitness centers view their own business models. For example, certain boutique fitness centers may want to have a premium membership model if they know that most of their patrons prefer to be in a certain area of the fitness center, e.g. in the front row of the exercise machines, and would pay more to reserve these machines ahead of time. In embodiments configured to advertise on the exercise machines, premium memberships may also prevent such advertisements from being displayed while in use by such a member. Operators could also use the systems and methods described herein for diagnosing when exercise machines break down the most (and when), such as by displaying error codes on the operator display 202 for the machines that are overused.

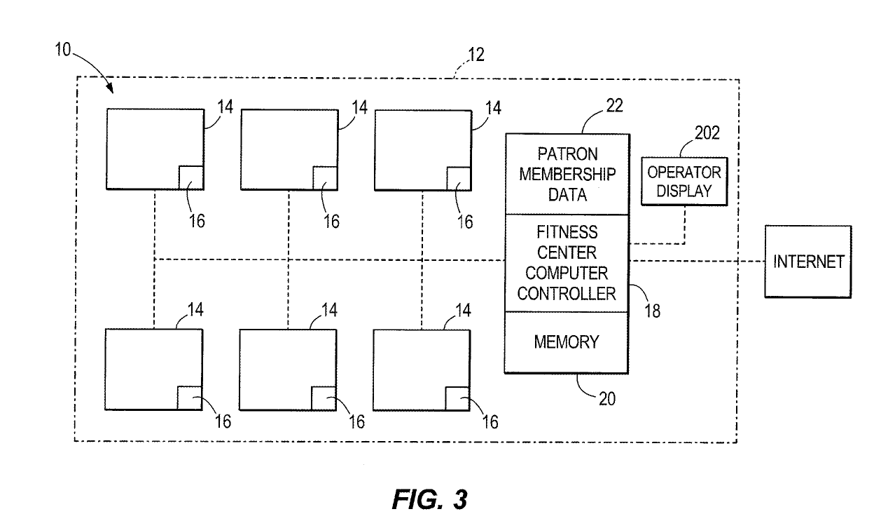

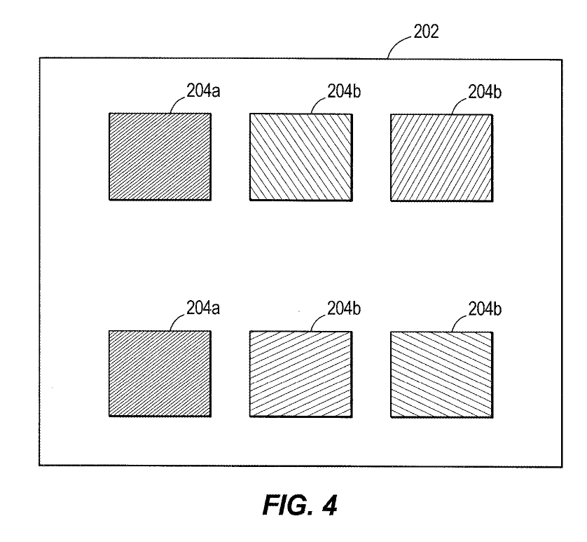

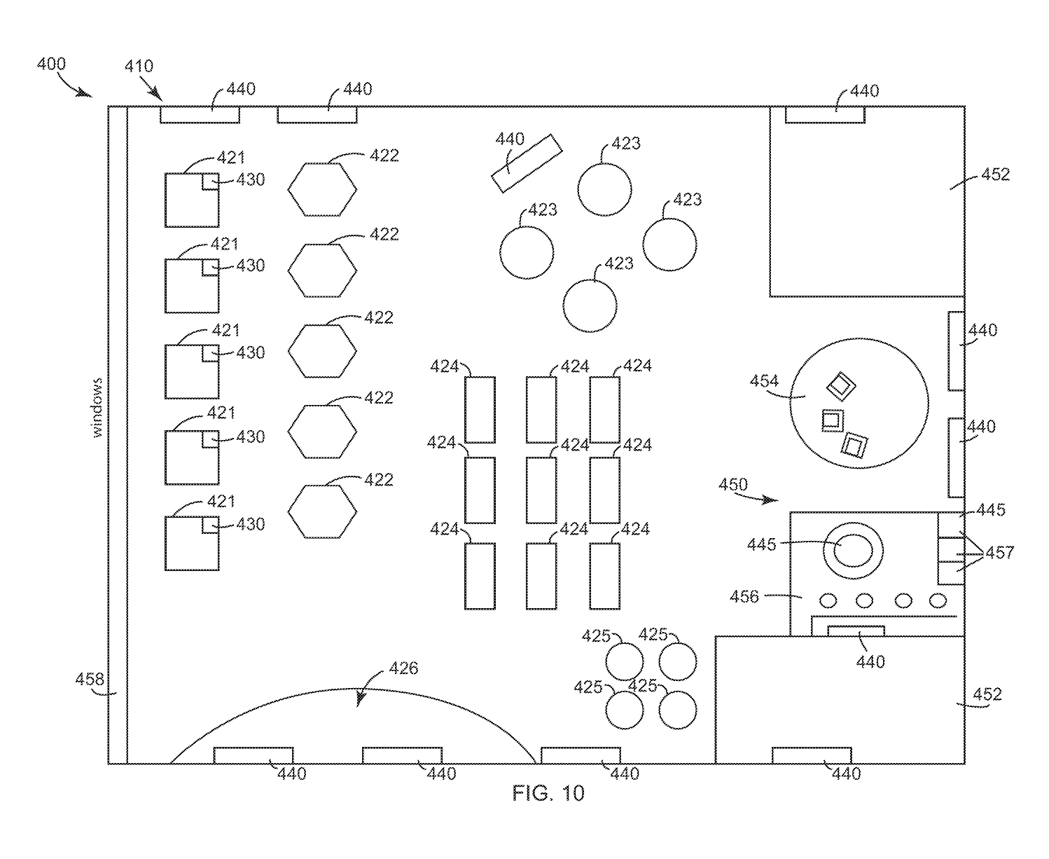

FIG. 3 depicts one example of a system 201 according to the present disclosure for monitoring and displaying usage of exercise machines at a fitness center 12. The system 201 includes the above-noted plurality of exercise machines 14 located at the fitness center 12. An operator display 202 is provided for illustrating locations of the exercise machines 14 with respect to each other. A more detailed map 400 showing additional assets (both equipment and non-equipment can also be displayed, such as is shown in FIG. 10 discussed below. An example of the operator display 202 is provided in FIG. 4. The above-described fitness center computer controller 18 is configured to control the operator display 202. As described herein above, the computer network communicatively connects the fitness center computer controller 18 to each exercise machine 14.

The fitness center computer controller 18 is uniquely configured to actively modify the operator display 202 based upon actual usage of each exercise machine 14 by patrons of the fitness center 12. In the illustrated example, the operator display 202 has a plurality of icons 204a 204b, each representing the location of an exercise machine 14. The fitness center computer controller 18 is configured to actively modify each icon 204 based on usage of the corresponding exercise machine 14. In some examples, the fitness center computer controller 18 is configured to actively modify the operator display 202 at predetermined time intervals. In other examples, the fitness center computer controller 18 is configured to continuously actively modify the operator display 202, i.e. in real-time.

The fitness center computer controller 18 is configured to modify a visual characteristic of each icon 204 based on the usage of each exercise machine 14. The fitness center computer controller 18 can be configured to correlate (e.g., map) different visual characteristics to different actual usage times of each exercise machine 14. In particular, exercise machine(s) 14 having a higher usage are displayed with a first visual characteristic and exercise machine(s) a relatively lower usage are displayed with a different, second visual characteristic. For example, the visual characteristic can include different colors, cross-hatching, different relative sizes, and/or the like of the icon 204 to the remaining icons 204. Referring to FIG. 4, the exercise machines represented by icon 204a have a higher usage and thus are differently shaded compared to the exercise machines represented by icon 204b, which have relatively lower usage.

In some examples, each respective exercise machine 14 in the plurality of exercise machines 14 has the display and input device 16, as described in the examples herein above. The fitness center computer controller 18 can be configured to communicate with the display and input device 16 via the network. The fitness center computer controller 18 can be configured to communicate with any other conventional sensor on the exercise machine 14. Based on either or both of these connections, the fitness center computer controller 18 can be configured to monitor, via the network, the actual usage of the respective exercise machine 14.

In some examples, the fitness center computer controller 18 can be further configured to control each display and input device 16 to display one or more items for sale, as described herein above. In this manner, each display and input device is configured so that a patron can input an order to purchase the item for sale, and so that upon entry of the order to purchase the item for sale to the display and input device 16, the fitness center computer controller 18 is configured to validate and apply credit account information of the patron to thereby complete payment for the items for sale. The combination of the unique operator's display and the advertising and sales configurations described herein above, and the unique control and operator display methods described herein above, thus advantageously improves the operator's ability to direct advertising and sales to preferred exercise machines based upon usage (also referred to as traffic).

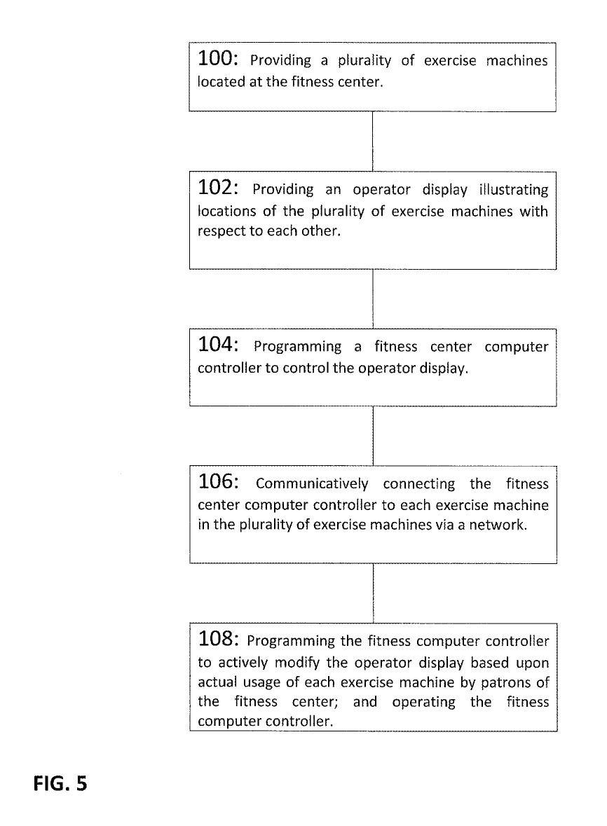

Referring to FIG. 5, the present disclosure provides methods for monitoring traffic flow at a fitness center. The methods can comprise (at step 100) providing a plurality of exercise machines located at the fitness center; (at step 102) providing an operator display illustrating locations of the plurality of exercise machines with respect to each other; (at step 104) programming a fitness center computer controller to control the operator display; (at step 106) communicatively connecting the fitness center computer controller to each exercise machine in the plurality of exercise machines via a computer network; and (at step 108) programming the fitness computer controller to actively modify the operator display based upon actual usage of each exercise machine by patrons of the fitness center; and operating the fitness computer controller.

As previously described, the present inventor has realized that it would be advantageous to provide improved systems and methods for advertising to patrons of a fitness center based on traffic, incorporating both the systems and methods for advertising and selling to patrons and the systems and methods for monitoring and displaying usage of exercise machines within the fitness center. Therefore, in addition to advertising being more targeted and uniquely tailored to each patron, the selection of specific advertisements and corresponding monetization from third-parties can be more directly controlled by the operator of the fitness center.

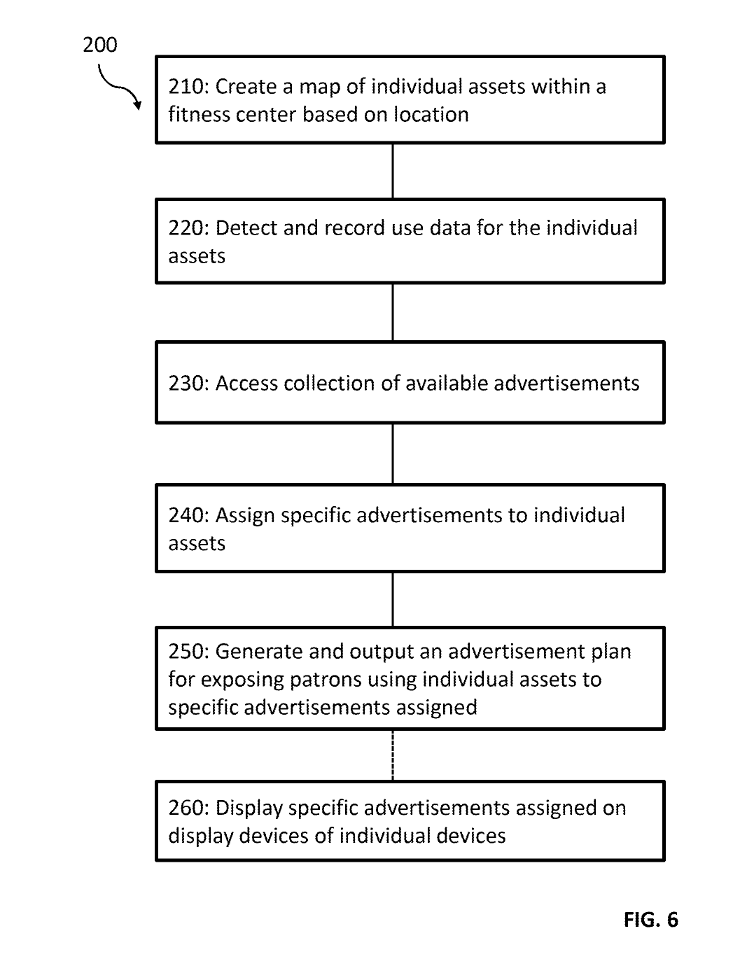

Through research and development, the present inventor has further improved upon the advertisement of goods and services based upon the traffic or use of assets within a fitness center. FIG. 6 depicts an exemplary method for advertising to patrons in a fitness center according to the present disclosure. The method 200 includes creating a map of the collection of assets based on respective locations within the fitness center (step 210). The collection of assets includes equipment, such as treadmills, stationary bikes, and the like, but also non-equipment assets, such as water fountains, break areas, locker rooms, and even the various regions within the fitness center that are valued by patrons. The method further includes detecting and recording use data for individual assets within the collection of assets as a function of time (step 220). This detection of use may be determined through different techniques previously described above and the references incorporated herein. Generally, these often include the use of sensors that detect occupancy of an individual asset, and/or sensors that detect actual use of an individual asset by a patron (i.e. peddling a bicycle versus merely sitting on the seat). In certain embodiments, this detection and recording further includes determining which particular patron is occupying or using the individual asset, whereas other embodiments simply detect and record use by anyone.

Next, the method includes accessing a collection of available advertisements (step 230), which may be stored centrally or on a third-party server, for example. The available advertisements may include any combination of advertisements that can be communicated through individual assets of exercise machines themselves, on digital displays throughout the fitness center, on print displays, as displays of physical goods within the fitness center, over a speaker system in the locker rooms, or other modes and locations for advertising goods and services known in the art. As previously described, these advertisements may be directed toward third-party goods and services, or goods and services offered by the fitness center itself, such as fresh made protein shakes or services with certified trainers.

The method 200 further includes assigning specific advertisements from within the collection of advertisements to individual assets within the collection of assets based on the use data detected and recorded in step 220 (step 240). In certain embodiments, the assignment of specific advertisements to individual assets is based on the relative popularity of a given individual asset compared to others within the collection of advertisements. This relative popularity may be of one individual asset relative to all other assets at the fitness center, or may be determined within a particular group of assets comprising a same type of equipment, such as comparing only within treadmills or cardio equipment more generally, for example.

Once the specific advertisements have been assigned to individual assets, the method further includes generating and outputting an advertising plan for exposing patrons who are using the individual assets to the specific advertisements assigned (step 250). In other words, the advertisement plan is based on the assignments of the specific advertisements to each of the individual assets determined in step 240.

It should be recognized that the same specific advertisement may be assigned to multiple or even all assets simultaneously. For example, one high-value advertisement may be assigned to every advertising asset (whether affiliated with a specific individual asset or a broad region within the fitness center) during the peak hours of fitness center traffic for a certain number of days and a certain fixed frequency.

In certain embodiments, the method 200 further includes displaying the specific advertisements assigned to individual assets on display devices corresponding to those individual devices in step 260. In some embodiments, this entails displaying the specific advertisements on the display device of an individual asset to which the specific advertisement was assigned, and/or to a wearable device worn by the particular patron using that individual asset at the time. Furthermore, these display devices include a wide variety of devices capable of displaying advertisements, such as monitors integral with the individual assets, monitors mounted throughout the fitness centers near one or more groups of asset, and/or monitors associated with non-equipment assets, such as in the locker rooms, break areas, or consultation desks where trainers and other staff members are located.

In addition to advertisements being of a visual format, others may include advertisements as sound (such as radio ads, including for patrons using streaming music services), as well as advertisements that include both visual and sound components. Similarly, advertisements may be stationary, such as a printed picture or poster on a wall within the fitness center, and/or videos including dynamic pictures and sound.

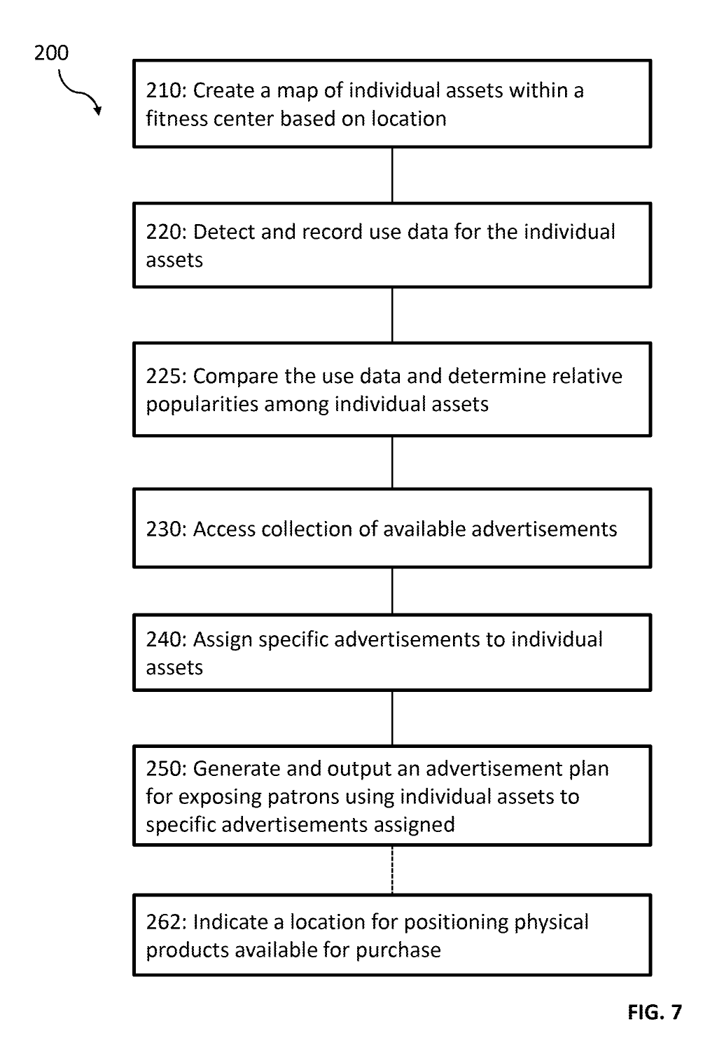

FIG. 7 depicts a method 200 similar to that shown in FIG. 6, but further incorporating the step of comparing the use data from step 220 to determine the relative popularities among individual assets (step 225). As previously described, this relative popularity may be within a group of assets or within one of the different types of equipment, such as among treadmills or stationary bikes. This comparison is then incorporated into the step of assigning specific advertisements to the individual assets in step 240, as well as generating and outputting the advertising plan for exposing patrons to these assigned specific advertisements in step 250.

The method 200 of FIG. 7 further depicts the step of indicating a location for positioning physical products available for purchase (step 262), such as purchasable devices, protein bars, water bottles, and apparel, for example. In other words, the advertising plan output generated and outputted in step 250 in certain embodiments includes optimized suggestions for positioning physical products within the fitness center. These suggestions may relate to the positioning of products already offered for sale in the fitness center, and/or suggestions for new products that may be of interest for the patrons of the fitness center.

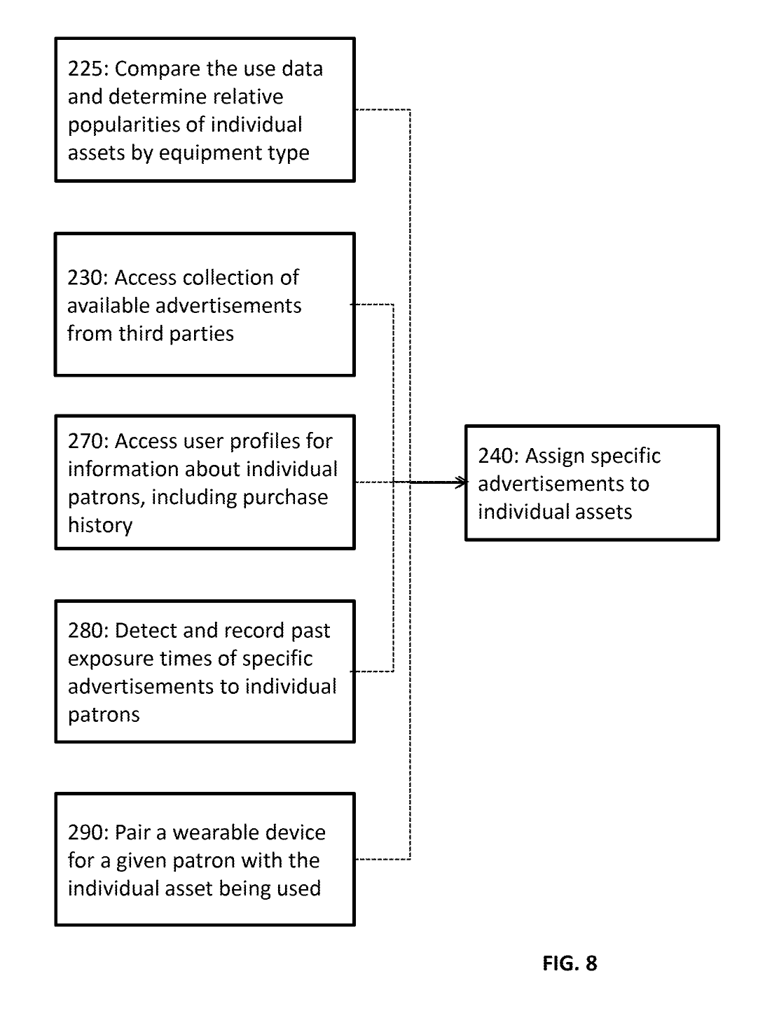

FIG. 8 depicts some of the exemplary data that may be gathered, inputted, and otherwise considered in the step of assigning specific advertisements to individual assets in step 240. As previously described, this may include the step of comparing the use data and determining relative popularities of individual assets by equipment type (step 225), as well as accessing collections of available advertisements from third parties in step 230. The assignment in step 240 may further include data from accessing user profiles to obtain information about the individual patrons (step 270). This may include demographic information such as gender, age, and income level, membership type, and/or the purchase history of each patron. This user profile information may also incorporate records of past advertising exposures for a given patron, including the specific advertisements and durations of these past exposures. This user profile information may help determine a conversion rate of advertisements to actual purchases, as well as help to test or sample the interests of an individual patron over time (step 280). In certain embodiments, the assignment of specific advertisements to individual assets in step 240 includes the step of pairing a wearable device of a given individual patron with the individual asset being used by that given patron (step 290). Pairing the wearable device can provide further information about the given patron, as well as indicating the potential for advertising directly to the wearable device in conjunction with, or instead of, other platforms for the specific advertisements to be assigned.

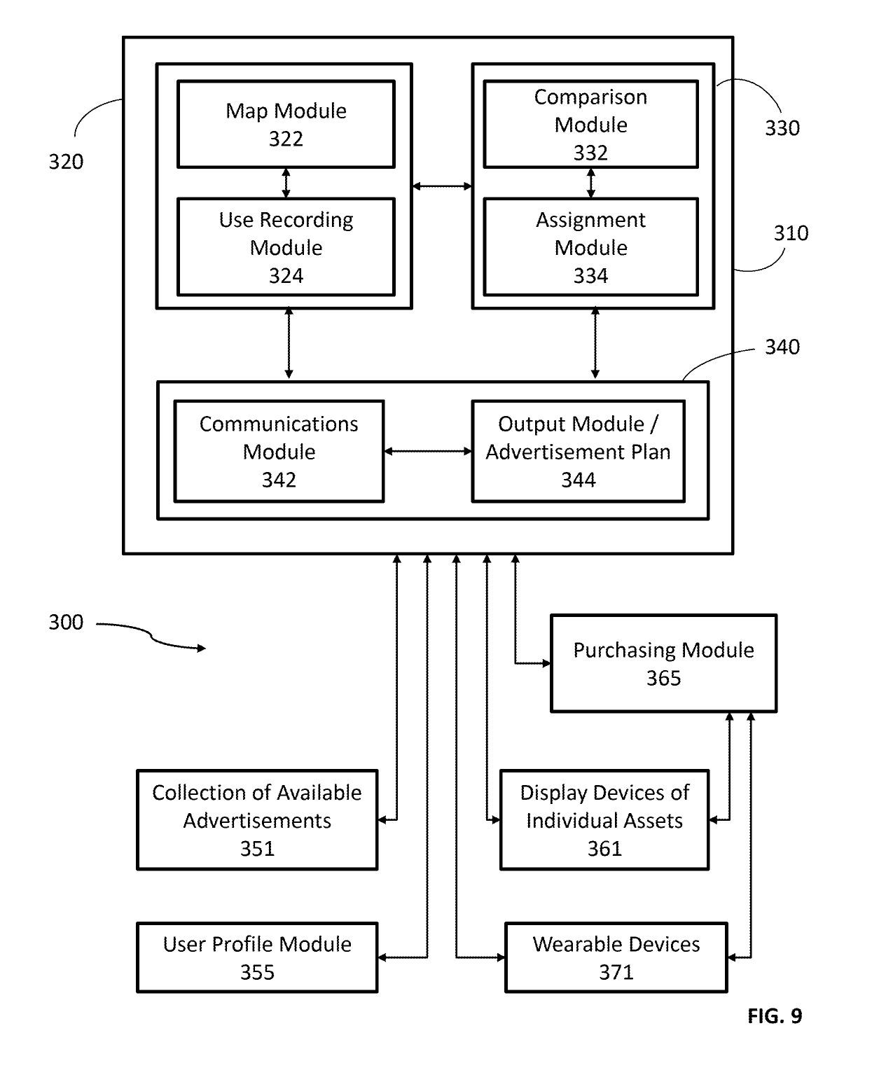

FIG. 9 depicts an exemplary system for advertising to patrons of a fitness center, including in a manner similar to the exemplary processes previously discussed. The system 300 includes an advertisement assignment module 310 that incorporates a memory module 320, a processing module 330, and an input/output module 340. A map module 322 within the memory module 320 is configured to store a map of the collection of assets based on respective locations within the fitness center. An exemplary map 400 is shown in FIG. 10, which will be discussed further below. The memory module 320 further incorporates a use recording module 324 that records use data for the individual assets within the collection of assets as a function of time.

It should be recognized that FIG. 9 depicts only one possible embodiment for structuring and interconnecting the elements described within the system 300. Specific elements may be divided out or combined with others, and the lines drawn between elements demonstrate only one possible path for communication therebetween. Such connections may also comprise wired and/or wireless connections, as previously stated.

In the embodiment of FIG. 9, a comparison module 322 is provided within the processing module 330 and is configured to compare the use data stored in the use recording module 324 for each of the individual assets. The comparison module 322 may determine a relative popularity of the individual assets as previously described, or may simply determine usage as a function of time. A communications module 342 within the input/output module 340, which is also in communication with the memory module 320 and the processing module 330, is configured to access a collection of advertisements available for advertising to the patrons. As previously discussed, this collection of available advertisements 351 may be central to the system 300 or another system within the fitness center, or may be a third-party database that is accessible over the internet, for example.

An assignment module 334 within the processing module 330 is configured to assign specific advertisements from within a collection of available advertisements 351 to each of the individual assets within the collection of assets. In certain embodiments, this assignment is based on the relative popularities determined for each of the individual assets with the comparison module 332. An output module 344 within the input/output module 340 is configured to output an advertisement plan, which indicates which of the specific advertisements to expose to the patrons using each of the individual assets once again, this may entail displaying an advertisement directly on an individual asset, or on another advertising asset within its proximity.

As depicted in FIG. 9, certain embodiments of the system 300 are in further connection with a user profile module 355, which is configured to store information about the patrons for further consideration by the assignment module 334 when assigning the specific advertisements to each of the individual assets. In certain embodiments, the system 300 further communicates with a purchasing module 365, which allows patrons to purchase the goods or services advertised in the specific advertisements. This purchasing module 365 may be incorporated into the display devices of individual assets 361 and/or wearable devices 371 of the patrons using an individual asset. In certain embodiments, the purchasing module 365 is an app loaded on the individual asset or wearable device 371. This may also include apps provided by third-parties that interact with individual assets via application programing interfaces (APIs). In other embodiments, the display devices of the individual assets 361 and/or the wearable devices 371 may also or instead be provided in communication with the system 300 directly, which has a separate purchasing module 365. As previously described, the purchasing module 365 enables the patron to make real-time purchases. In certain embodiments, this includes enabling one-click purchases of desired goods and services through embedded incorporation with payment devices or membership information to provide a cashless transaction with no cashier involvement.

In certain embodiments, a patron is required to log into an individual asset prior to using it. In such cases, this enables a connection between the purchasing module 365 and financial information stored within the patron's login account or wearable device 371, such as credit card information.

FIG. 10 depicts an exemplary map 400 according to the present disclosure. Such a map 400 may serve as an input, such as at step 210 for the methods previously described, as well as a potential output as an advertisement plan generated at step 250 according to the present disclosure. The exemplary map 400 depicts a collection of assets 410 that includes a variety of assets. These include individual assets that can be categorized within groups of assets 421-426, as well as advertising assets 440 and non-equipment assets 450. In certain embodiments, advertising assets 440 include digital displays such as monitors (including within the individual assets), as well as posters and audio transmission systems, such as locker room speakers. In certain embodiments, these advertising assets 440 include displays of physical goods available for purchase (advertising assets with goods 445), such as a display of water bottles, snacks, or fitness equipment.

Exemplary non-equipment assets 450 include such assets as locker rooms 452, consultant areas 454, and break areas 456, which may further include vending machines 457. In certain embodiments, windows 458 within the fitness center further comprise non-equipment assets 450, as these constitute attributes of a fitness center that may bring value to a patron, but are not fitness equipment.

In the exemplary map 400, a column of a first group of assets 421 is generally aligned to one advertising asset 440, whereas a parallel second group of assets 422 is substantially aligned to another advertising asset 440. These advertising assets 440 may display the same specific advertisement, or may display different advertisements that better cater to the specific patrons using the different groups of assets 421-422. In addition, certain individual assets further include their own display devices 430, which are shown to be incorporated within the first group of assets 421. Advertisements on these display devices 430 may be uniquely catered to the individual patrons using each of the individual assets, or may be uniform across all individual assets within the first group of assets 421.

Other groups of assets are also shown, which may also include a region of the fitness center where patrons participate in certain fitness activities, such as the sixth group of assets 426. In one embodiment, the sixth group of assets 426 comprises a stretching region, which may also include such assets as balance balls, jump ropes, or other small items. As with the first and second groups of assets 421-422, the sixth group of assets 426 may be assigned specific advertisements for its own advertising assets 440. The two advertising assets 440 shown within the sixth group of assets 42656 may display the same or different specific advertisements as each other, and/or the same or different specific advertisements relative to advertising assets 440 positioned near other groups of assets.

Through research and development, the present inventor has anticipated that certain traffic patterns within certain fitness centers may indicate a preference for certain types of individual assets over others, at least in part based on time of day, day of week, or location within a fitness center. For example, in a situation in which the first group of assets 421 and the second group of assets 422 are the same type of equipment, such as elliptical trainers, the use data detected and recorded in step 220 may indicate that the first group of assets 421 is nonetheless more popular, having a higher rate of use. This may be explained by the first group of assets 421 being closer to a wall and therefore somewhat more private than other locations within the fitness center. Another explanation may be the proximity of the first group of assets 421 to the windows 458, depending upon the view thereof.

Accordingly, the present inventor has identified that different specific advertisements may be better suited for exposing to patrons based on the time of day, the equipment being used, and the individual profile of the patron. Likewise, the owner and operator of a fitness center may be able to optimize advertisement revenue by not only matching potential interests to individual patrons, but also by assigning higher-paying advertisements to more popular individual assets.

The advertisement plan generated and outputted in step 250 may also assist the owner of a fitness center in positioning stationary advertising assets 440, such as advertising assets with goods 445. In addition to determining an optimized location for positioning advertising assets with goods 445, the particular goods to be displayed within the advertising assets with goods 445 is also assigned and provided with the advertising plan in step 250. For example, the advertisement plan generated and outputted in step 250 may suggest that the owner of the fitness center obtain an advertising asset with goods 445 displaying a certain type of apparel near the sixth group of assets 426 where yoga instruction is held. The advertising plan may also recommend an advertising asset 440 (such as a stationary poster) advertising a particular muscle-building supplement proximal to a group of assets related to weight-lifting. The advertising plan may also change over time even where traffic is consistent as new goods and services become available, or as previous exposures approach a level or reduced impact.

In certain embodiments, the assignment of specific advertisements to individual assets is provided on a rotating fixed cycle, whereas others are uniquely matched up to the particular patron using a given individual asset. In these examples, different levels of advertisement revenue are anticipated between the targeted marketing, and the fixed impression rate of the fixed rotation schedule. Likewise, additional advertising revenue may be generated depending upon whether advertising directly to the wearable device of a patron, to a display device within the individual asset being used, to a digital video display within the region, via a physical poster in the region, or via an overhead-audio advertisement within the fitness center, for example.

In the present description, certain terms have been used for brevity, clearness and understanding. No unnecessary limitations are to be implied therefrom beyond the requirement of the prior art because such terms are used for descriptive purposes only and are intended to be broadly construed. The different systems and methods described herein may be used alone or in combination with other systems and methods. Various equivalents, alternatives and modifications are possible within the scope of the appended claims.

What is claimed is:

1. A method for advertising to patrons of a fitness center using a collection of assets, the method comprising:
creating a map of the collection of assets based on location within the fitness center;
detecting and recording use data for individual assets within the collection of assets as a function of time;
comparing the use data among each of the individual assets to determine a popularity for each of the individual assets;
accessing with a collection of advertisements available for advertising to the patrons;
assigning specific advertisements within the collection of advertisements to each of the individual assets within the collection of assets based on the popularity determined for each of the individual assets; and
outputting an advertisement plan indicating which of the specific advertisements within the collection of advertisements to expose to the patrons using each of the individual assets within the collections of assets, wherein the advertising plan is based on the assignment of the specific advertisements to each of the individual assets.

2. The method according to claim 1, wherein a group of assets within the collection of assets corresponding has display devices, further comprising displaying the specific advertisements assigned to the individual assets within the group of assets on the display devices.

3. The method according to claim 2, wherein the display devices are monitors integral with the individual assets within the group of assets.

4. The method according to claim 1, wherein the collection of assets includes different types of equipment, and wherein the specific advertisements assigned to the individual assets with one of the different types of equipment are displayed other than on the individual assets within that one of the different types of equipment.

5. The method according to claim 4, wherein the popularity for each of the individual assets is determined relatively within each of the different types of equipment, and also for each of a plurality of periods throughout a day.

6. The method according to claim 1, wherein the map further includes non-equipment assets within the collection of assets.

7. The method according to claim 1, further comprising detecting and recording past exposure times of the specific advertisements to the patrons over a period of time and considering the past exposure times of the specific advertisements when assigning the specific advertisements within the collection of advertisements to each of the individual assets.

8. The method according to claim 1, further comprising determining which individual patron is using a given asset within the collection of assets when assigning the specific advertisements to the given asset.

9. The method according to claim 8, further comprising collecting profile information for the patrons, and further comprising considering the profile information when assigning the specific advertisements to each of the individual assets.

10. The method according to claim 1, further comprising pairing a wearable device of a given patron to a given asset within the individual assets being used by the given patron.

11. The method according to claim 10, further comprising advertising on the wearable device the specific advertisements assigned to the given asset.

12. The method according to claim 10, further comprising collecting patron information about the given patron from the wearable device, and further comprising considering the patron information when assigning the specific advertisements to the given asset.

13. A system for advertising to patrons of a fitness center using a collection of assets, the system comprising:
a map module configured to store a map of the collection of assets based on location within the fitness center;
a use recording module configured to record use data for individual assets within the collection of assets as a function of time;
a comparison module configured to compare the use data among each of the individual assets to determine a popularity for each of the individual assets;
a communications module configured to access a collection of advertisements available for advertising to the patrons;
an assignment module configured to assign specific advertisements within the collection of available advertisements to each of the individual assets within the collection of assets based on the popularity determined for each of the individual assets; and
an output module configured to output an advertisement plan, wherein the advertisement plan indicates which of the specific advertisements to expose to the patrons using each of the individual assets within the collections of equipment.

14. The system according to claim 13, wherein the collection of advertisements is stored within the system.

15. The system according to claim 13, further comprising a user profile module configured to store profile information about the patrons, wherein the profile information includes past purchases by each of the patrons, and wherein the assignment module is configured to consider the profile information when assigning the specific advertisements to each of the individual assets.

16. The system according to claim 13, wherein a group of assets within the collection of assets corresponding has display devices, wherein the output module is further configured to output the specific advertisements assigned to the individual assets within the group of assets to the display devices in accordance with the advertisement plan.

17. The system according to claim 13, wherein the collection of assets includes different types of equipment, and wherein the comparison module is further configured to determine the popularity for each of the individual assets is determined relatively within each of the different types of equipment.

18. The system according to claim 13, wherein the use recording module is further configured to determine which given patron of the patrons is using a given asset within the collection of assets, and wherein the assignment module is further configured to consider the given patron using the given asset when assigning the specific advertisements to the given asset.

19. The system according to claim 18, wherein the given asset is configured to pair with a wearable device of the given patron using the given asset, wherein the given asset is configured to obtain patron information from the wearable device, and wherein the assignment module is further configured to consider the patron information when assigning the specific advertisements to the given asset.

20. The system according to claim 19, wherein the output module is further configured to output the specific advertisements assigned to the given asset to the wearable device of the given patron that is using the given asset, further comprising a purchasing module configured to enable the patrons to purchase the goods advertised in the specific advertisements and wherein the purchasing module is configured to communicate with the individual assets such that the goods are purchasable through the individual assets.
